(19) United States
(12) Patent Application Publication
(10) Pub. No.: US 2008/0104524 A1
(43) Pub. Date: May 1, 2008

(54) System and Method for Facilitating Ip Telephony Applications

(76) Inventors: Timothy J. Van Hammond, Appleton, WI (US); Nicholas A. Tseffos, Appleton, WI (US); Scott J. Timmons, Kaukauna, WI (US); John H. Ptacek, Appleton, WI (US); Jeffrey P. Lang, Manasha, WI (US)

Correspondence Address: GODFREY & KAHN S.C., 780 NORTH WATER STREET, MILWAUKEE, WI, 53202, US

(21) Appl. No.: 10/548,160

(22) PCT Filed: Mar. 3, 2004
(86) PCT No.: PCT/US04/06483

§ 371 Date: Jul. 23, 2007

Related U.S. Application Data
(63) Continuation-in-part of application No. 10/378,588, filed on Mar. 4, 2003, now abandoned.

(51) Int. Cl. G06F 3/048

(52) U.S. Cl. 715/762

(57) ABSTRACT

A system and method enabling designers to create IP telephony applications without the need for the designers or IP telephone users to understand either the native data format used by the IP telephones or emulators or the programming language used to construct the IP telephony applications. IP phone devices such as IP telephones and/or emulators may also be provided with the ability to receive and play audio and video streams using associated handsets, speakers and visual displays. Platforms may be creating enabling the use of IP telephony applications and associated IP phone devices to accomplish data transfer either statically or dynamically, and also utilizing web services and/or LDAP applications, and other remote sources of information.

### CROSS-REFERENCE TO RELATED APPLICATION

This application is a continuation-in-part of application Ser. No. 10/378,588, filed Mar. 3, 2003.

### BACKGROUND OF THE INVENTION

The invention generally relates to a system and method useful for demonstrating, designing, deploying and maintaining IP (Internet Protocol) telephony applications.

More specifically, the invention provides an easy to use system for creating IP telephony screens displayed on IP telephones or appropriate IP telephone emulators. The system is designed to allow designers to construct IP telephony applications without the need for the designers or end users to have any specific knowledge either of the programming language which the IP telephones use to display information (e.g., XML, ASCII, etc), or of IP technology or IP infrastructure.

A principle benefit of IP telephony, in comparison with traditional phone systems, is to take advantage of converging networks. In the past, telephony and data networks were separate. This separation required the customer to acquire different skills sets to manage each network. Telephony systems have utilized proprietary programming and protocols for the switch, different from IP data networks. In the converged world, using IP protocol as the standard, both telephony and data are able to run on the same network. This reduces cost by eliminating the need for separate personnel to manage each network, allowing customer data personnel to manage communication in a single type of network.

Existing IP telephony systems employ application servers to provide advanced functionality for IP telephones beyond dial tone (i.e., to provide additional applications for the phone). These application servers utilize XML documents or other means for displaying information on the phone. To take one example, an application available from Cisco Systems, Inc., which is called Call Manager®, functions as an application server for that IP telephony phone routing system. In the Cisco implementation, an IP telephone displays data transmitted in an XML format, using CISCO XML phone objects or schema. Constructing applications in such a system requires advanced technical proficiency in not only XML but also in the use of Cisco's XML phone objects or schema. As a result, the ability of sales and sales engineer personnel to quickly demonstrate applications to prospective customers, and the ability of purchasers to generate their own applications, may be severely limited, in that an inordinate amount of training and skill is required.

This invention relates to improvements over the systems described above, and to solutions to the problems raised or not solved thereby.

### SUMMARY OF THE INVENTION

The present invention provides a system enabling a user to easily create IP telephony applications, and may be used by personnel not extensively trained in a specific underlying application architecture or IP technology, enabling such personnel to quickly design, create, and publish applications for an IP telephony phone or emulator. An emulator may be used to simulate the final implementation of the application, or to enable a user to use the application using only a personal computer, in the absence of an IP telephony phone set. The system leverages a simple Windows-based, or other graphical, interface, allowing even non-technical and sales personnel to create applications that demonstrate and use the power of integrated IP telephony. The invention further provides a design tool, useable with IP telephones/phone devices or accompanying, third-party phone emulator software on a Windows PC, for example, which would permit nontechnical personnel to design IP telephony applications with customers, viewing the results on-screen using IP telephones/phone devices, in real-time if desired. IP telephony objects could then be generated and displayed as separate screens on the IP telephone to create a screen-by-screen presentation. Alternatively, a Call Manager® (or similar) environment may be set up so that the design tool may be used to develop applications for actual IP telephone/phone devices. The invention also allows IP telephony designers to program in third and/or fourth generation computer languages if desired, and to provide IP telephony applications with a full range of audio and video capabilities. The invention further provides IP telephony designers with platforms by which IP telephony applications may be designed and implements to permit users to statically or dynamically transfer information in connection with the use of web services if desired, or databases, and/or to interface with LDAP applications if desired, for example.

The present invention provides the features described above, in a design tool which can allow nontechnical personnel to others to dynamically create applications for IP telephones without the need for extensive manual coding. One preferred embodiment of the invention allows designers to construct IP telephony applications accessible and employable by users of IP telephones or IP telephone emulators. The system enables the designers to construct the IP telephony applications by manipulating IP telephony objects, such as on a graphical user interface, to create data in a native format used for display of information to the users of the IP telephones or the IP telephone emulators. The system allows the designers to construct the IP telephony applications and the users to utilize them without the designers and users being required to understand either the native data format or programming language used to construct the IP telephony applications.

In a particularly preferred embodiment, one or more IP telephones may have a graphical user interface including a first visual display, and a keypad associated therewith. The designer may construct an IP telephony application using a second visual display which may show, for example, flow diagrams facilitating construction of the IP telephony application. This second visual display may be associated with the designer's computer, network server, PDA or other machine or device. The IP telephony objects manipulated by the designers may be represented by icons, and the second visual display may include a canvas for dragging and displaying the icons. In a particularly preferred embodiment, the second visual display includes a toolbox of the IP telephony objects represented by icons which may be linked together during design of the IP telephony applications, and the second visual displays also has a toolbar and/or menu command which permits the IP telephony objects to be saved and published. Preferably, the system permits the IP telephone designer to use the graphical user interface to selectively display and arrange the IP telephony objects on the canvas without utilizing the programming language.

IP telephony applications used with the present invention may be either static, in which information on the first visual display is not based on real-time data derived from requests made by the users, or dynamic, in which information on the first visual display is based on real-time data derived from requests made by the users, or a combination of both. Preferably, the system allows the IP telephony user to dynamically select existing images in various formats and convert the images to a format necessary to allow the user to interpret the information on the first visual display, such format may be, but need not be limited to, industry-standard formats such as TIFF, GIF, BMP, PNG and/or JPEG.

The system of the present invention may be designed to function on a Windows®-based platform, as well as on non-Windows®-based platforms.

The native data format may be of various forms, including but not limited to XML, HTML or ASCII text.

The system of the present invention may interface with IP telephony objects derived from images originating from the Internet and/or from a file system of a computer in communication with one or more of the IP telephones. The system also permits the designer to create IP telephony objects, as defined by an IP telephony vendor, in the native data format of the IP telephone derived from databases, network data stores, directory services and/or local file stores or network file stores which may include but are not limited to text files, spreadsheet files, or word processing files

In an alternative embodiment, a system is provided which enables IP telephony applications to be developed from IP telephony objects is provided, which in turn permits users of IP telephones or IP telephone emulators to access and employ the IP telephony applications. The system enables the designers to construct the IP telephony applications by manipulating IP telephony objects to create machine-readable data utilized by IP telephones to convey information to the users. Neither the designers nor the users are required to understand the programming language in order to develop and use the IP telephony applications.

In another alternative embodiment, a method is provided wherein a designer constructs an IP telephony application accessible and employable by users of IP telephones or IP telephone emulators. A plurality of IP telephones or IP telephone emulators are provided, each having an associated first visual display. One or more designers are provided with computers, the display of which constitutes a second visual display. The designer constructs the IP telephony application using software enabling the designer to visually manipulate elements on a graphical user interface associated with the one or more second visual displays to create data in a native format used for display of information by the IP telephones to the users. The designer constructs the IP telephony application, and the users use an IP telephone or IP telephone emulator running the IP telephony application, without the need for either the designer or the users to understand either the native data format used by the IP telephone or IP telephone emulator, or the programming language used to construct the IP telephony application. The IP telephony applications thus constructed may be either static or dynamic, or a combination of both.

In yet another alternative embodiment, the system allows audio stream objects to be included in the platform and applications built using the system, via native objects or third party API components, and to be played on an associated IP telephone handset, speaker or through the emulator. For example, streaming audio may be incorporated, a well as enabling text-to-speech or speech-to-text capability within the applications developed.

In a further alternative embodiment, the Software video objects may be included in applications built using the Software and may be played on an associated IP telephone handset, speaker or through the emulator. For example, streaming video may be received, as well as enabling video conferencing and/or video record capabilities. Of course, audio and video capabilities may be provided in a single unit.

Other objects and advantages of the invention will become apparent hereinafter.

### BRIEF DESCRIPTION OF THE DRAWINGS

FIG. 1 is a schematic diagram of a network placement topology for a preferred embodiment of the present invention,

FIG. 2 is a use flow diagram for a preferred embodiment of the invention,

FIG. 3 is an exemplary visual display of an IP telephone using an embodiment of the invention, shown as would appear in a screen shot from an emulator application,

FIG. 4 is an exemplary screen shot for a preferred embodiment of the invention in use,

FIG. 5 shows the dialog showing the properties of one of the graphical images identified as shown in FIG. 4,

FIG. 6 shows an exemplary screen shot illustrating a Text Object with embedded tags,

FIG. 7 is an application map pertaining to a business demonstration of the invention referred to in the written specification,

FIGS. 8-10 are high level diagrams representing building blocks according to the invention, showing how these may be utilized in various ways,

FIG. 11 is a schematic view of an IP telephony application server and design studio according to one preferred embodiment of the present invention, showing that a base platform using the system shown in the earlier figures can enable end-user native or custom applications,

FIGS. 12 and 13 are exemplary network diagrams supporting audio and video capabilities, respectively,

FIG. 14 shows an IP telephone screen with the Text Object in FIG. 6 at run time with the tags resolved,

FIG. 15 is a schematic view according to one embodiment of the present invention, illustrating tag functionality,

FIG. 16 is an exemplary screen shot, in one embodiment, prior to clicking and dragging a Graphic file menu to the canvas,

FIG. 17 is an exemplary screen shot, following the operations shown in FIG. 16, illustrating how in this embodiment the graphic menu may be used to link sub-objects to the main menu,

FIGS. 18 and 19 show the touch screen dialog that may appear, in this embodiment, following the operations in FIGS. 16-18, indicating the graphic file menu item coordinates,

FIG. 20 shows the canvas results, in this embodiment, that result from the operations described in connection with FIGS. 16-19, and

FIGS. 21-23 show properties screens for certain of the objects disclosed in connection with the invention.

### DETAILED DESCRIPTION OF THE PREFERRED EMBODIMENTS

The invention provides a system that permits display of a toolbox of IP telephony objects, a toolbar of common functionality, a canvas for dragging and displaying icons, and menu commands. While in the preferred embodiment the Software is designed to run on a Microsoft Windows®-based platform, it is contemplated that it may be run on platforms other than Windows® (e.g., Unix®, Linux®, Mac OS, etc.)

IP telephony applications permit data to be presented in various different representations. Each of these representations, such as a menu, a text screen, an image, etc., is referred to here as an IP telephony object. IP telephony objects are defined by the IP telephone vendor to operate within their IP telephony architecture. In the present invention, for each IP telephony object type, there exist one or more corresponding icons in the toolbox. These icons may be dragged (via a designer or end-user mouse or touch-screen operation or in another suitable manner) and applied to the screen canvas Designers or user may click on items on the canvas to supply the specific information for that IP telephony object necessary to create the IP telephony screen. Numerous icons may be place on the canvas to create the dynamic flow of an application.

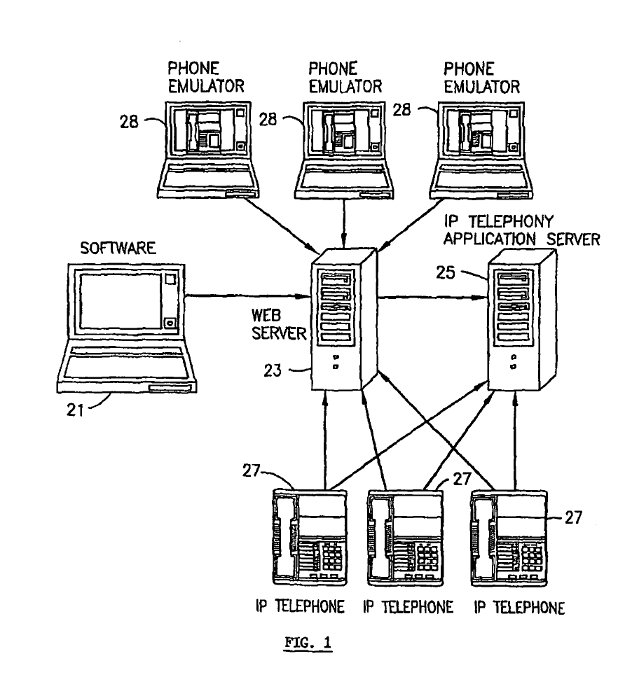

Referring now to FIG. 1, a preferred network topology placement for use with the present invention is shown, in which system of the present invention may be running on a personal computer 21, for example. IP telephones 27 may access an intermediate server, such as an IP telephony application server 25, which provides a directory of information enabling access to Web server 23. Web server 23 may be located anywhere on the Internet, or may be located within a specific network. Phone emulators 28 may also access Web server 23, as shown. Hereinafter, IP telephones 27 and phone emulators 28 are at times collectively referred to as “IP phone devices.”

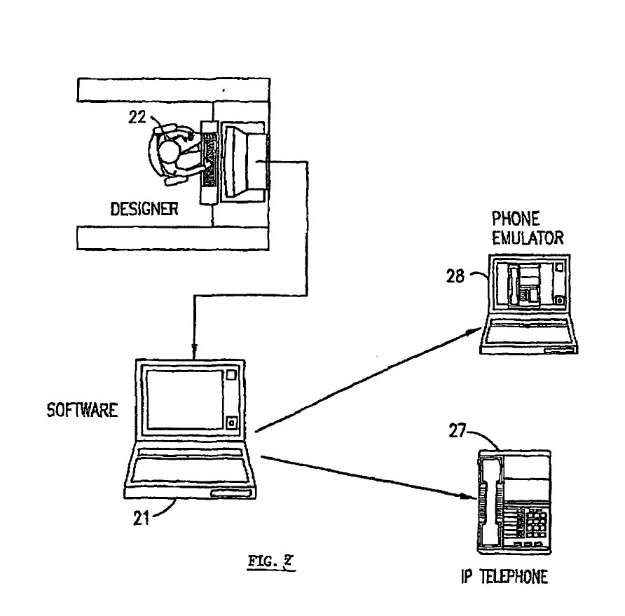

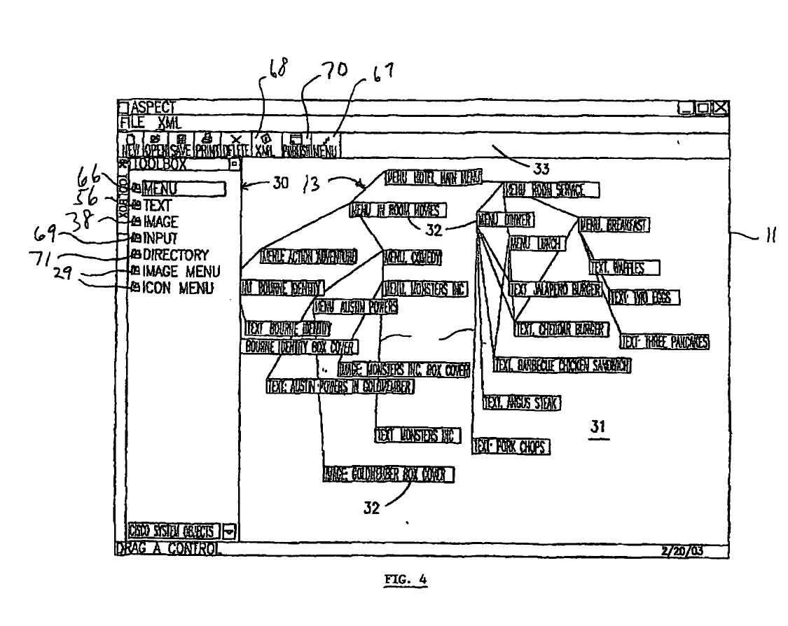

Referring now to FIGS. 2, 3 and 4, FIG. 2 shows a use flow diagram, in which a designer 22 communicates with a personal computer 21 running the system, where the computer is connected to a network, for example. According to the invention, the system publishes files, which are made accessible to a phone emulator 28 that runs in software and/or an IP telephone 27. FIG. 4 shows a screen shot 11 created by IP telephony application designer 22 using the system of the present invention. The screen shot 11 shows a toolbox 30 with icons 29, each having functionality to create and manipulate in a predetermined way any IP telephony objects 32 displayed on a canvas 31. A toolbar 33 is positioned generally at one edge of the screen, but may also be free floating. IP telephone application designer 22 may view the native data format for any IP telephony object 32 on the application canvas 31, and such objects may be linked together as shown, to indicate their relationships, and thus create a menu tree 13. Such a menu tree 13 may be “published,” or saved to a suitable location, for viewing and use by either phone emulator 28 or IP telephone 27 (FIG. 2).

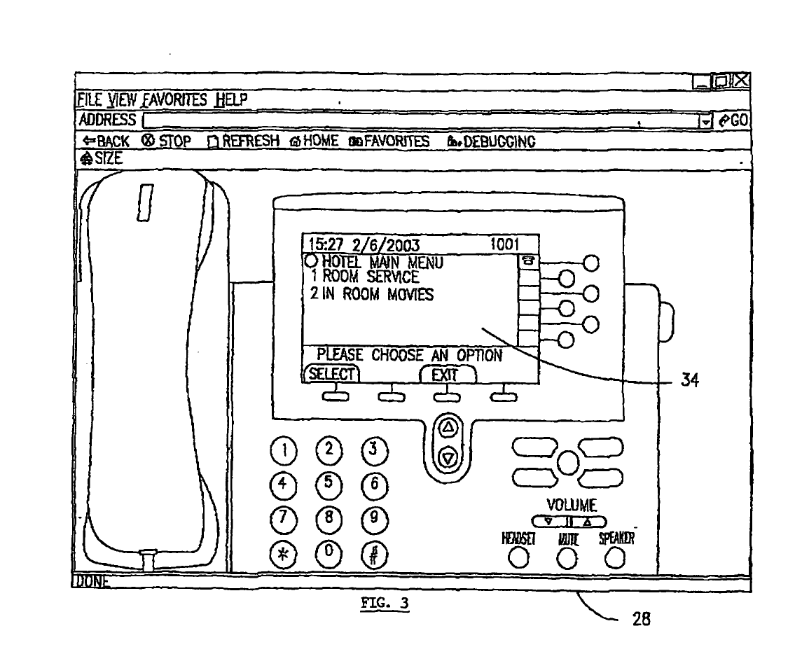

As one example, an application may be written to provide room service information and/or movie information to the visual display 34 on an IP telephone 27 in a hotel room (FIG. 3). The IP telephone 27 may access application server 25, requesting a particular movie. Server 25 may then access a server, such as Web server 23, to obtain and serve up the selected movie. As another example, the system may utilize industry-standard Open DataBase Connectivity (ODBC) functionality, which permits the designer 22 to construct an IP telephony application using a front-end tool not requiring specific programming language knowledge, for accessing certain information in a database. For example, visual display 34 of the IP telephone 27 of FIG. 3 shows a Hotel Main Menu offering room service and in-room movies. Using the telephone keypad, this menu may be accessed and, referring to FIG. 4, items/phone objects 32 linked to the menu may be dragged from toolbox 30 to canvas 31 to create the display shown in FIG. 4. The designer end-user 22 may use the toolbox 30 to place icons on the canvas 31, providing access to databases for the hotel guest. In this manner, the invention provides the ability to connect to virtually any database and develop applications for IP telephony systems.

When the IP telephone application designer 22 hits the “publish” button 36 on the toolbar 33, information entered on the visual display 34 (by filling the text boxes, for example) for display on an IP telephone will be converted by the system to IP telephony phone objects 32, e.g., Cisco XML phone objects. The native format of these IP telephony objects 32 is thus published to an application server, e.g., a web server that can serve files (e.g. XML), at a location accessible to either the emulator 28 and/or the IP telephone 27.

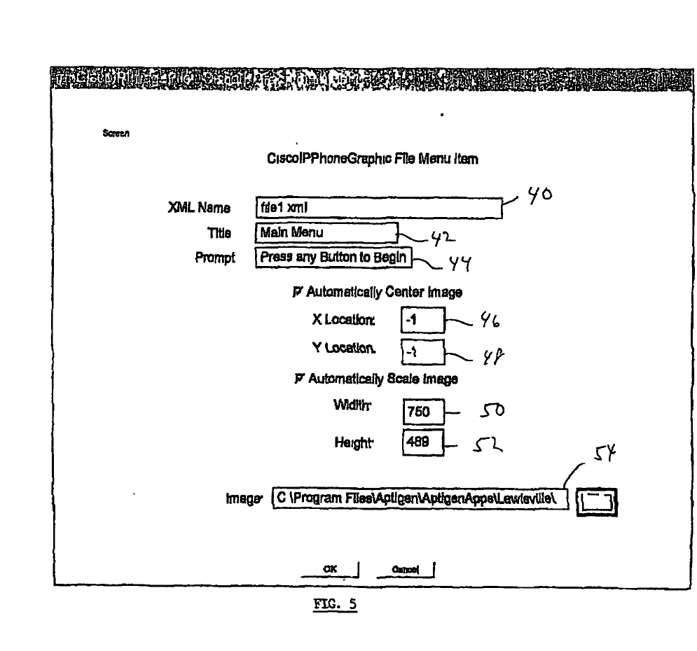

Still referring to FIGS. 3 and 4, using the system of the present invention, an image desired to be displayed on an IP telephone 27 or emulator 28 may be created by following these steps. (The following is specific to a Cisco IP telephony implementation, but those of ordinary skill in the art will understand that other IP telephony implementations may be used following similar methods.) First, the image icon 38 is selected from the toolbox 30, and dragged (or mouse-clicked) from the toolbox to the canvas 31. A window such as that shown in FIG. 5 may then be displayed with the information required to create an image. In the “XML Name” box 40, the XML file name to be displayed may be entered. If desired, in the Title box 42 a title may be entered for display on the XML phone (here, XML Phone refers to either an actual IP Telephone 27 or the IP Telephone emulator 28). Also, if desired, in the Prompt box 44, a prompt may be entered for display at the bottom of the XML phone display. In the X Location box 46 and Y Location box 48, the X and Y locations of the Image on the phone display may be entered. In the Width box 50 and Height box 52, the corresponding width and height may be entered, if necessary. In the Image box 54, an image file is identified for conversion and display on the phone. The designer 22 may either provide the URL of an image on the Internet, or the exact name of the file on the local file system, or the user may browse the computer file system to find the desired file. Alternatively, check boxes permit the designer to decide if the image is to be scaled to fit on the phone or is to be centered in the display, in which case width, height and location values do not need to be entered. Clicking “ok” closes the window.

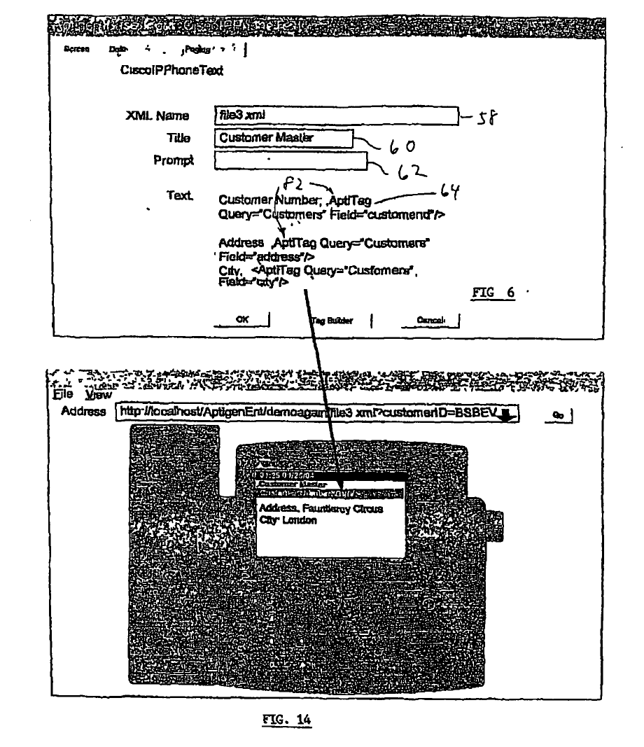

To create a text message that will ultimately be displayed on IP Telephone 27 or emulator 28, the following steps may be taken. First, the text Icon 56 is located in the toolbox 30, and the icon may be dragged (or mouse-clicked) from the toolbar to the canvas 31. A window is then displayed as shown in FIG. 6 with the information required to create a text screen. In the XML Name box 58, the XML file name may be entered for the text to be displayed. If desired, in the Title box 60 a title may be entered for display on the XML phone. Also if desired, in the Prompt box 62 a prompt may be entered for display at the bottom of the XML phone display. In the Text box 64, the text information to be displayed on the phone may be entered. Clicking “ok” closes the window.

To create a menu screen to be displayed on IP Telephone 27 or emulator 28, first, the Menu Icon 66 in the toolbox 30 is located, and dragged or mouse-clicked from the toolbar to the canvas 31. Similar to the Image and Text functions, but not shown explicitly, a window may display some of the information required for the Menu. In an XML Name box, and XML file name is entered for display. If desired, in a Title box a title may be entered for display on the XML phone. Also if desired, in a Prompt box a prompt may be entered for display, as well. Next, the designer may connect existing elements on the canvas 31 with the menu icon on the canvas to add the actual item or selection to the menu. This may be don by (1) clicking the Menu button 67 in the toolbar 33, (2) selecting the newly created menu icon on the canvas 31 (dragged over or mouse-clicked from the toolbox 30), and (3) selecting the icon to be displayed on the menu. The title entered for the icon may be used for the menu item description. By double clicking the connecting line, referred to as a Menu Link 15 (FIG. 4), between a menu and its selections, the relationship between the menu and its selections may be changed, as will be described in more detail below.

Similarly, the Input Icon 69 is used to provide the means to accept text input usable by the system, such as for a password, or data to be input into a database.

The Directory Icon 71 facilitates the designer creating a phone directory to be displayed on IP Telephone 27 or emulator 28. The invention thus provides a very easy, yet very powerful, way to connect the telephone system to the company's LDAP directory, beginning by simply dragging and dropping the icon. The company thereby avoids the necessity of separate data sources for different types of information about the company's users, including phone number and other information.

To view an icon's XML code, the icon may be highlighted and the XML button 68 on the toolbar 33 is selected. To publish the application, that is, to make it available for use on IP telephones 27 and IP telephone emulators 28, the Publish button 70 on the toolbar 33 is selected.

By way of background concerning the image creation process, for an existing IP telephony application, images to be displayed on the screen of the IP telephone phone 27 may be translated to a specific format for the IP telephone platform using vendor-developed or platform-developed Dynamic Link Libraries (DLLs). The system allows the designer or end-user to dynamically select an image in many standard formats, such as TIFF, GIF or JPEG, and use a DLL or other conversion process to convert the image to the format necessary for display on the telephone 27 or emulator 28. This may be accomplished by choosing an image from a local or networked file system or by providing a URL address. No knowledge of the image creation process is required, and ease of use is improved.

Ease of use may be further improved by the inclusion of templates and/or wizards, which would give a relatively untrained designer or user additional guidance in the arrangement of the various elements. A template would take a user through a series of questions, and present a limited number of possible responses from which to choose. And a wizard would provide a user with further guidance about the usage of the features of the invention. While templates and wizards are not necessary to the operation and use of the system of the invention, they make that use more efficient and easier also for the occasional user.

In the preferred embodiment, the system was created using the programming language C#. However, it will be understood by those of ordinary skill in the art that the system may also be created for varying applications using a variety of other languages, such as, but not limited to, Java®, Visual Basic, C++, Perl, PHP, COBOL, Fortran, and other computer languages not yet developed.

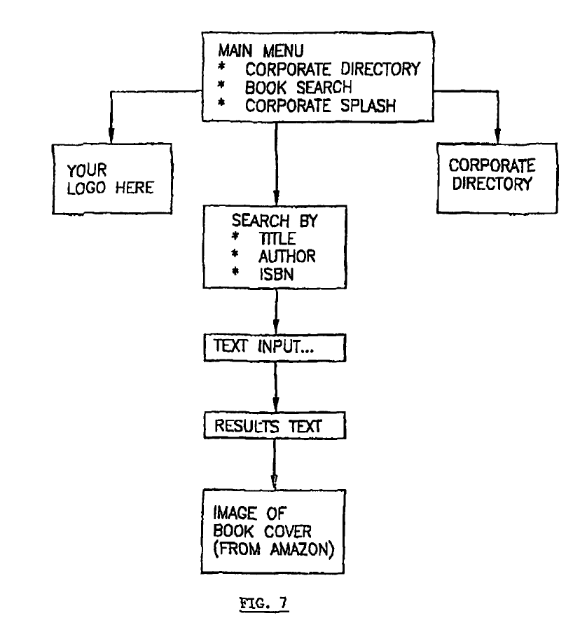

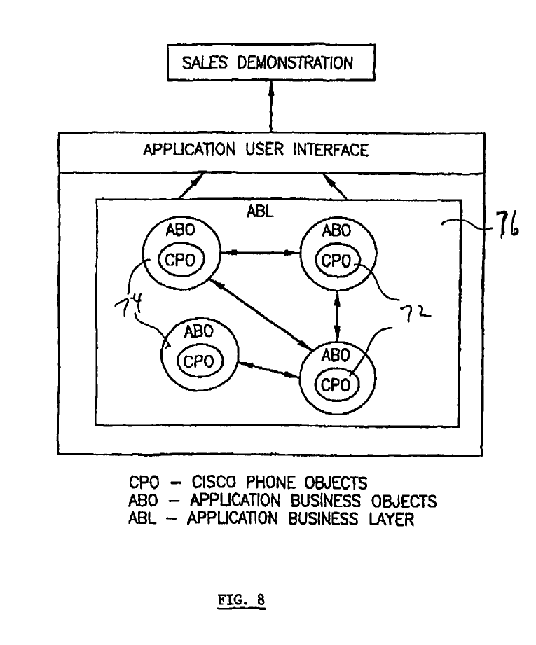

Referring now to FIGS. 7-10, another aspect of the invention provides a development platform for trained professional programmers to use in preparing end user applications. To illustrate this use of the invention as a platform, an exemplary demonstration using the invention in that manner is shown. In this example, a bookstore, “CB,” located near a college campus, has a business strategy of meeting or beating the prices of Amazon.com on any book sold. CB decides to sue Cisco IP telephones to minimize the hardware and support costs associated with personal computers. CB has developed for it an easy to use IP telephony application to search Amazon.com on behalf of CB's employees and customers. FIG. 7 shows an application flow diagram of an IP telephony application deployed to an IP telephone for “CB” employees and customers accessing IP telephones located at “CB” Bookstore. At some point, then, an IP telephone application designer (e.g., a CB Bookstore employee) would create the final application using the system of the invention. Even before that, however, as shown in FIG. 8, Cisco phone objects (“CPOs”) 72 may be “wrapped” into business objects 74, termed Application Business Objects, created by professional programmers. These Application Business Objects in total are referred to as the Application Business Layer 76 upon which the user interface of the system of the present invention relies. The use of such wrapped business objects removes the end user or designer further from the actual programming. As an example, relating to the bookstore example referred to above, an example of an Application Business Object would be a graphical image file format converter, for converting an image file from the GIF or JPEG file found on a web site to the PNG format, or other format that the vendor's (e.g., Cisco's) phone objects are capable of handling. Creating such a file converter from scratch would be an immense effort, which effort can be avoided by simply using this particular Application Business Object. There are many other examples of such uses of wrapped business objects. In short, use of wrapped business objects provided by the system of the present invention reduces complexity, increases standardization, and provides a migration path facilitating designer construction of IP telephony applications that are not based on vendor (e.g., Cisco)-specific phone object language.

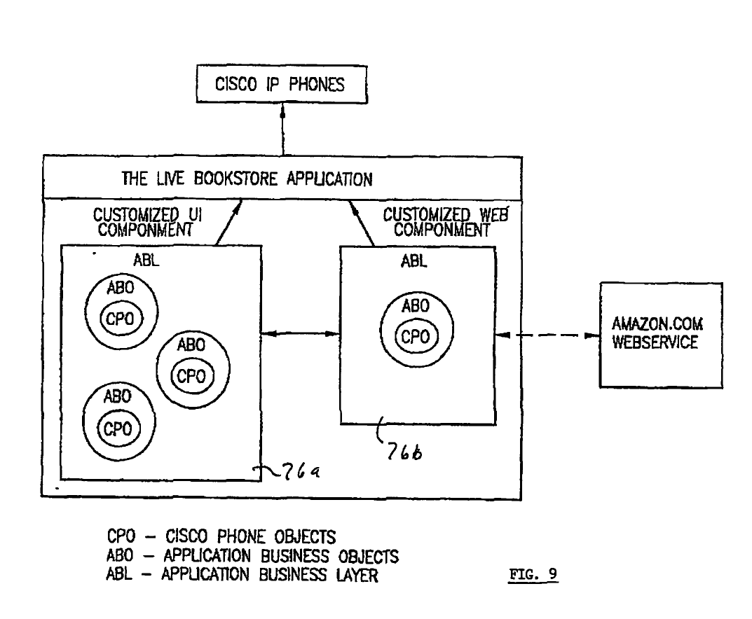

Referring to FIG. 9, the Application Business Layer 76 may be used by the system to create a dynamic application based on user requests (“Live Bookstore Application”). The Live Bookstore Application may utilize the Application Business Layer 76 to create a customized UI component for displaying information on the IP Telephone. The UI component takes advantage of a customized web component which may then access the Amazon.com web service, and is usable by the (e.g.) Cisco IP telephones. This customized web component may be a vendor's own application, using building blocks provided by the system, for a static IP telephony application.

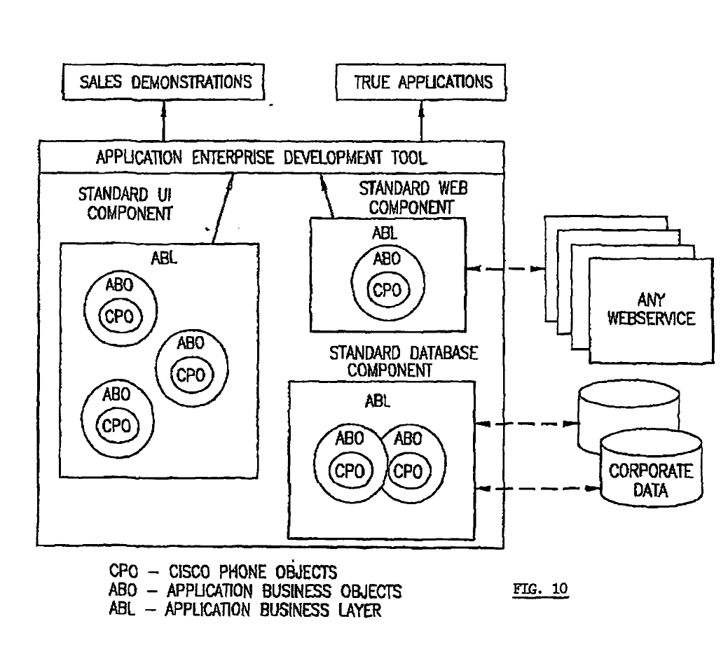

Thus it can be seen that, to create a dynamic IP telephony application, the system can function, besides merely being a prototyping tool, to actually constitute a development platform. Referring to FIG. 10, the creation of elaborate objects allows the provision of sophisticated features without requiring custom programming. In a preferred embodiment, such features may include any or all of a) web-service integration components, b) database integration components, and c) dynamic user interaction, as illustrated in FIG. 10.

It will now be appreciated that the system of the present invention allows the designer to create text, menu, image, input or icon objects, in the native data format of the IP telephone 27 or IP telephone emulator 28, that are derived from one or more of the following many different file types, including text files, spreadsheet files such as Excel® or Lotus®, word processing files such as MS Word® or Word Perfect®, or image files such as PNG, GIF, BMP, TIFF and/or JPEG, information from many different sources, including databases, files from local file stores, or network data or file stores, files from Internet resources directory services (e.g., Microsoft's Active Directory, Novell Directory Services or LDAP), third party applications, such as an Enterprise Resource Planning (ERP) system, a Customer Relationship Management System (CRMS), or web services. Similarly, image objects, image menu objects and/or icon menu objects may be created in real time from data collection services such as programmable logic controllers and the like.

As described above, the system and its application platform preferably include two major components (1) a design studio, and (2) an IP telephony applications server. The design studio is preferably an easy-to-use, Windows®-based application allowing the user to drag XML (or JAVA-based or other based) objects from a visual toolbox onto a designer canvas. Those existing objects are referred to herein as “design time objects.” By default, the toolbox may be populated with design time objects that are native to the system. The IP telephony applications server may be responsible for hosting the particular IP telephony application being addressed. It may also be responsible for hosting the run time version of the design time object. All design time objects must be converted to either pure XML or exist in a run time version.

Commonplace components having significant use to the customer base of the system can be designated as “native objects.” The native toolbox may contain such native objects for varied uses, such as database access, LDAP and/or web service integration, and other features such as text-to-speech/speech-to-text, video streaming and delivery, audio broadcasting, voice recognition, recording and playback, etc.

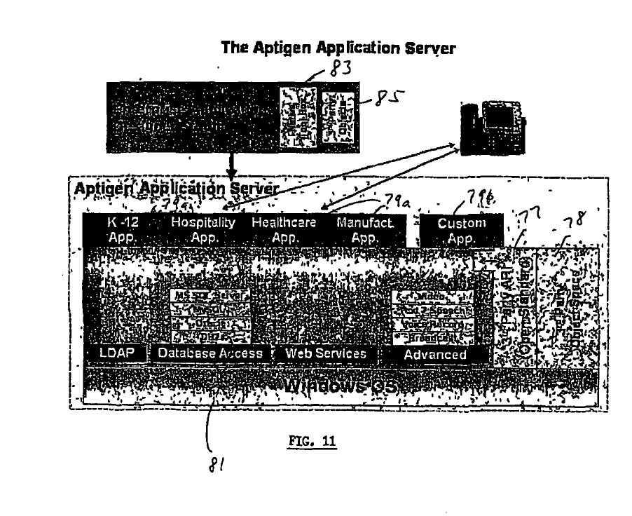

The native toolbox may be enhanced as the system is evolved. However, it is likely that there will always be features and functionality that, despite their need by elements in the customer base, are considered too advanced, detailed or obscure to form a part of the native toolbox. These features, referred to here as “third party objects,” are supported by the system and the design studio. For example, referring now to FIG. 11, if a third-party software developer desires its design time and runtime controls to be available in both the front end designer interface and the backend application server, it may first create both controls (design time and runtime versions) according to its published API (Application Programming Interface) Standard 77. The design time objects may be installed on a workstation housing the design studio, while the runtime objects may be installed on an application server in the “3^{rd} Party Object Space” 78, in compliance with a standard so that compatibility is achieved. (Note that the five boxes 79 above the term “Server Engine” represent applications that may be created by a third party software developer, for example).

To exemplify a preferred embodiment of the present invention, referring still to FIG. 11, using a “pure native objects” example, that is, an example were only objects from the native toolbox 83 are used, suppose a designer uses the system of the invention to create the designer's own specific XML application 79a. If the designer want to query or rely upon existing databases 81, which may be internal or external, to send information to the requesting IP phone 27 or emulator 28, the designer may do so and create all of the user interface forms and database integration components by leveraging the native objects already available in the native toolbox 83.

Taking another example, refer now to FIG. 11 for a hybrid of native objects and third party objects solution, in a custom application 79b. In this situation, which is not unique and in fact is somewhat common, the data to be accessed is stored in an outdated, obscure mainframe system at a remote location, possibly even halfway around the world. As a result, the designer is presented with several particular challenges that cannot be accommodated with objects from the native toolbox 83. However, the scalability and ease of use provided by the system, including the design studio, are still desirable. In order to achieve the desired functionality, a custom component (third party object) may be created to access the mainframe database. By writing to the published application programming interface standard, this third party object may be leveraged by the system, including the design studio. Additionally, because of the remoteness of the computer where the database is stored, a high compression of voice streaming to the IP phone/emulator is desired. While the system's native toolbox 83 may have a voice streaming component, as will be described below, in this case the user may still choose to purchase a specialized product from a third party, in order to provide the needed compression functionality. This is acceptable, provided that this third party object is compliant with the standard, it integrates well, is available to be added, such as in a third party objects toolbox 85, and is supported and converted to a runtime version on the IP telephony application server.

It should know be understood that use of the present invention permits dramatic time savings in IP telephony design, as it enables an IP telephony designer 22 to program in a fourth generation computer language, and removes the need to climb a relatively steep learning curve when attempting IP telephony programming in second and third generation languages. Correspondingly the required expertise level of IP telephony users is lowered as well. It will also be appreciated that the resulting IP telephony programs thus created may be employed as IP telephony teaching tools for designers or users. Further, it will be understood that system of the present invention provides a platform including preconstructed components so that IP telephony designer 22 can take advantage of existing applications, and even incorporate third party objects via API, rather than building them anew for each new application.

Much of the above disclosure has related to the abilities of an IP telephony product line to render applications on the display panel of the phone. The use of IP phones may be further enhances by providing expanded capabilities relating to audio and video improvements allowing, for example, the receipt of audio and/or video streams which may then be played on the IP phone's handset, speaker and/or associated display screens, or through an emulator.

Concerning audio enhancements, for example, it would be useful to send pre-recorded voice/sound to an IP phone upon invocation by an application option or upon receiving a live “broadcast” feed of audio termed here a “streaming audio” capability function. As another example, it would also be useful to provide the capability to have text stored in some type of file or database converted to a human audible voice and played back to the user onto the phone, termed here a “text-to-speech” capability or function. Conversely, it would be useful to provide the ability for an application to convert a human voice to text which may be stored in some document format, termed here a “speech-to-text” capability or function.

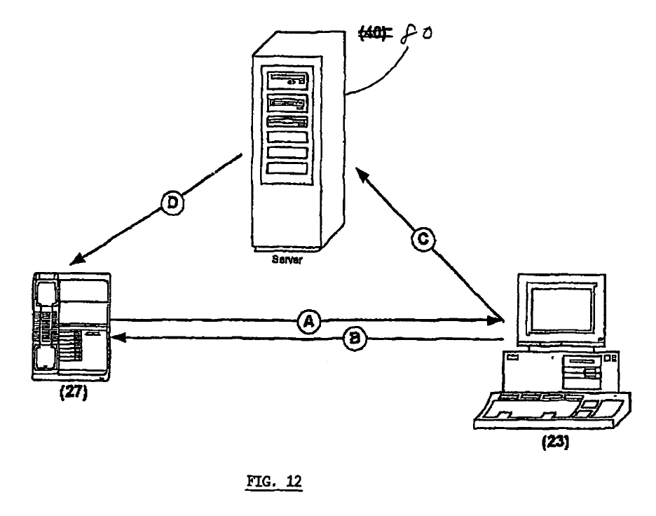

To implement this audio technology, several new IP telephony objects may be presented to the designer 22 as icons representing each type of ‘sound’ object such as (a) streaming audio, (b) text-to-speech, and (c) speech-to-text (voice or video recording). These IP telephony “sound” objects may be presented to the user in the toolbox 30 as described above, dragged onto the canvas 31, and connected to other objects on the canvas in a similar fashion to that described above. In addition, each of these “sound” objects may also be manipulated by designer 22 by changing options for the object. For example, and referring now to FIG. 12, the above-referenced IP telephony programs may be designed to work in conjunction with a Media Server 80 that streams the audio media to an IP telephone 27 or a phone emulator 28 (FIG. 2). Options for the IP telephony object may include the name of the Media Server 80 to send information to the phone, information concerning which media format the source (in the case of streaming audio) might be in, and the quality of the broadcast to be specified. Still referring to FIG. 12, IP phone 27 may first request an audio stream A to be transmitted, and to be identified using some parameter(s). Web server 23, which may be used to host the phone service, may then issue a command B to the IP phone 27 advising it to prepare to “listen” for and receive an audio stream. The Web server 23 may then direct Media Server 80 (which may be located on the same physical machine as the Web Server or, alternatively, may be located on a different machine) to send an audio stream C to the IP phone 27. That is, the Web Server 23 makes this request to the Media Server 80 on behalf of the IP phone 27. Upon receiving this request, the Media Server 80 may then send an audio stream D to the IP phone 27.

Concerning video enhancements, IP phone 27 may include a camera (not shown) similar to concept to a WebCam to provide the phone with a built-in video conferencing capability, for example. The built-in camera, along with the ability to show the video feed on the display, may also indicate that a similar set of video functions are available. Such video functions might include, for example, the ability to send a pre-recorded video to a phone upon invocation by an application option or receiving a live ‘broadcast’ feed of video similar to a television program broadcast, termed here a “streaming video” capability or function. Another video function may be the ability to programmatically select callers for inclusion in a video conference call, termed here a “video conferencing” capability or function. Yet another video function may be the ability for a user to request that the built-in or attached camera to the phone capture a video of the user and save it for future use or transmit it to a third party, termed here a “video record” capability or function.

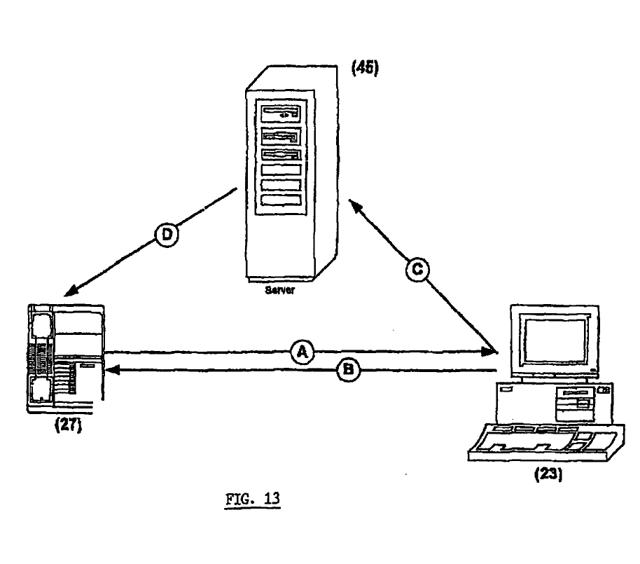

Again, these IP telephony “video” objects may be presented to the user in the toolbox 30, dragged onto the canvas 31, and connected to other objects on the canvas, in a similar fashion to that described above. Each IP telephony “video” object may also be manipulated by the designers by changing options for the object. For example, and referring now to FIG. 13, the above-referenced IP telephony programs may be designed to work in conjunction with a Media Server 45 that streams the video media to an IP telephone 27 or a phone emulator 28 (FIG. 2). Options for the IP telephony “video” object may include the name of the Media Server 45 to send information to the phone, information concerning which media format the source (in the case of streaming video) might be located in, information concerning the quality of the broadcast to be specified, etc. Still referring to FIG. 13, IP phone 27 may first request for video stream A to be transmitted, and to be identified by some parameter(s). Web server 23 may then issue a command B to the IP phone 27 advising it to prepare to “listen” for and receive a video stream. Web server 23 may then direct Media Server 45 (which may be on the same physical machine as the Web server or, alternatively, be located on a different machine) to send a video stream C to the IP phone 27, i.e., the WebServer makes this request to the Media Server on behalf of the IP phone. Upon receiving this request, the Media Server 80 may then send a video stream D to the IP phone 27.

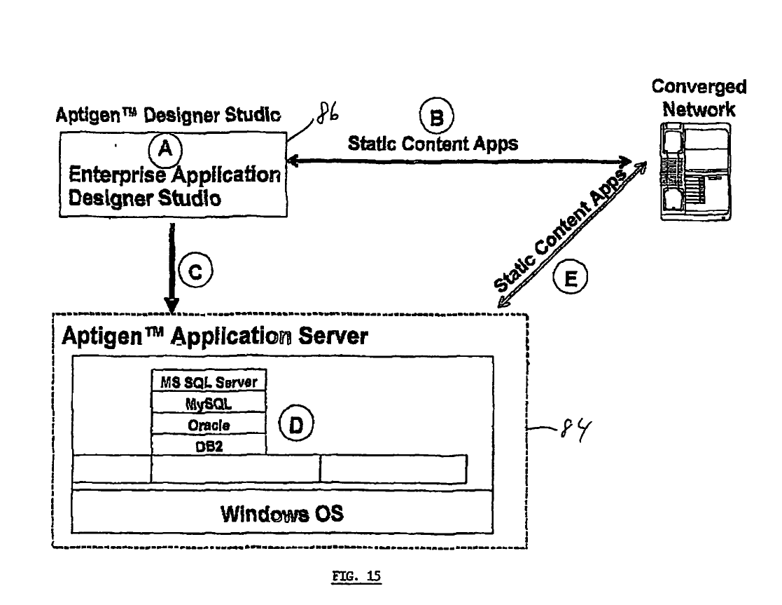

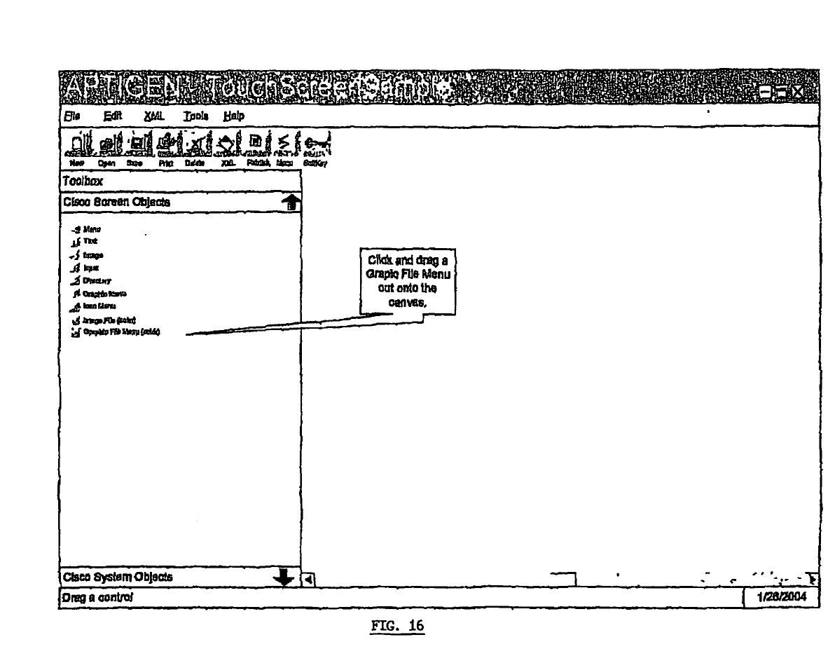

Referring now to FIGS. 6 and 15-23, further alternatives and improvements to the above-described technology will be described, particularly relating to dynamic rather than static operations. In a preferred embodiment, “tags” or “placeholders” have been found to be useful for accomplishing a conversion from static to dynamic operations. Referring back to FIG. 6, such a tag 82, when used by the version of the system commercialized by the assignee of the present invention, is referred to as an “AptiTag™,” which term is a trademark owned by the assignee of the present invention. This tag 82 is to be intercepted by the Application server 84 (see FIG. 15) and replaced with the resulting field from the query. In the example shown in FIGS. 6 and 14, the tag for “customers field=city” (FIG. 6) is be replaced by “Address Fauntleroy Circus [customer]” and “City London” (FIG. 14).

FIG. 15 shows the operation of this tag functionality in a preferred embodiment. Referring first to position “A” in FIG. 15, the designer studio 86 provides the user with the ability to insert tags within the static XML content (Aptigen™ is a trademark owned by the assignee of the present invention). Position “B” illustrates that any application can be built without advanced features (in other words, static content only, tags 82), such applications can be directly deployed to the IP phone 27 or emulator 28, because “tag resolution” (which will be described in more detail below) is not required. Position “C” shows that any application requiring advanced features may include tags 82. The tags 82 are stored in their “design time state” within the XML, and on the application server. (If the tags 82 are, alternatively, for example, embedded within a JAVA application, they may be delivered to the phone in their “design time state” or may have already been resolved by the server into their “run time state.”) At runtime, position “D,” the phone 27 makes a request for services to the Applications Server 84. The Application Server 84 intercepts the XML, strips out the tags 82, as they are mere placeholders, and replaces them with dynamic information derived from an advanced feature such as a database lookup, LDAP query, a sound bite clip representing audio, etc. Accordingly, by the time the application content is flowing to the phone 27 (at position E), all of the tags 82 have been resolved to their true values.

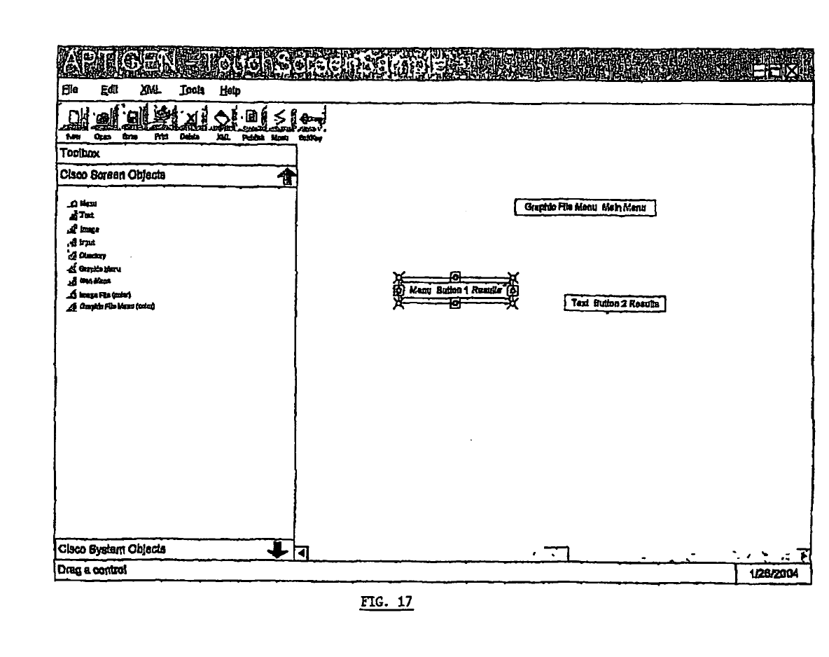

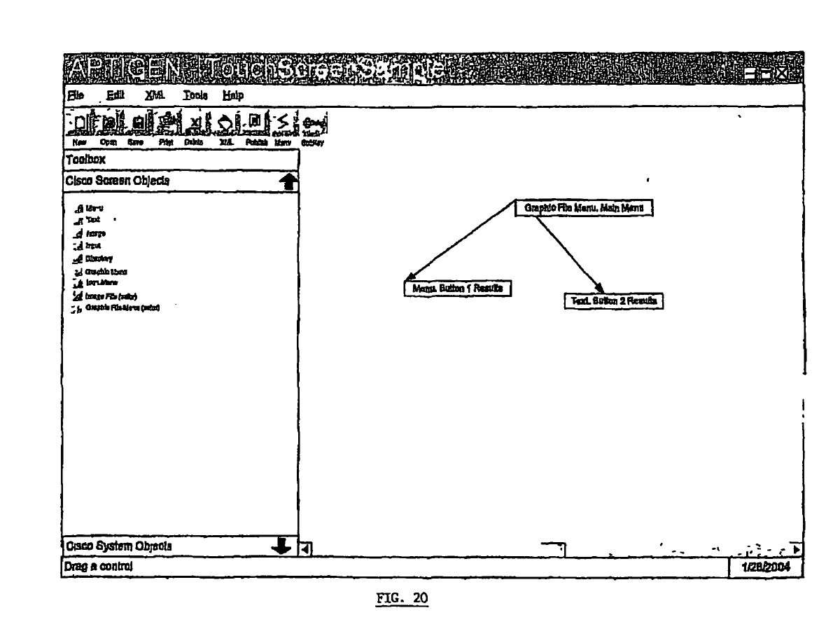

Referring now to FIG. 16, the system according to the invention allows the creation, for example, of rich color, touch screen user interfaces for applications such as kiosks. The touch screen menu may be implemented in a manner, for example, similar to the CISCO graphic file menu objects. That is, it may be created by dragging a “graphic file menu object” (as that termed is used by CISCO engineers using CISCO IP telephony systems) form the toolbox 30 out onto the canvas 31. (However, it will be understood that other touch screen menus may be used, as the present invention may be utilized with IP telephony systems other than those made by CISCO.) Referring again to FIG. 5, when the dialog appears, the user may point the image property to the desired image source file. Additional objects (“sub-objects”) may be linked into from the graphic menu, as shown in FIG. 17, in this embodiment, menu and text box sub-objects are used, although it will be understood that other types of sub-objects may be employed. Then, using the menu button, these sub-objects may be linked to the main menu, as shown in FIG. 20.

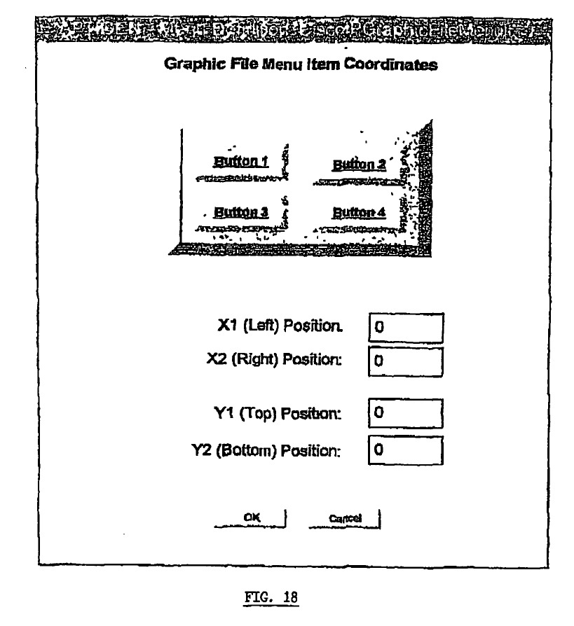

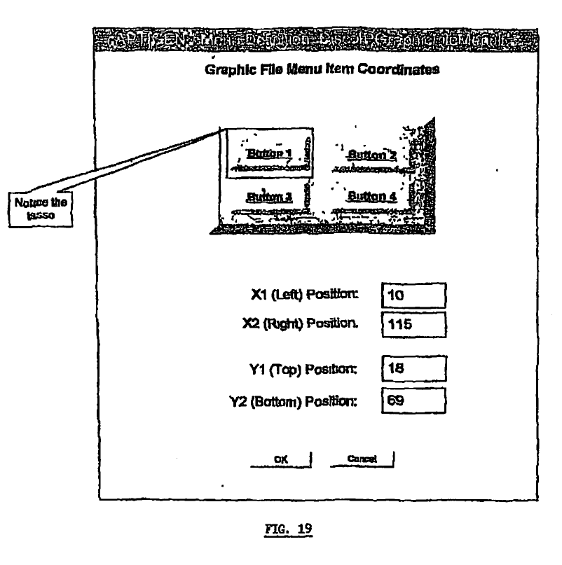

Referred to FIGS. 18 and 19, graphic file menu item coordinates may be selected. In one preferred embodiment, these coordinates may be quickly and easily selected using the technology now to be described. A touch screen dialog may be provided as shown in FIG. 18. The user's mouse may be used, for example, to draw a “hotspot” or “lasso” around the desired area, such as by holding the left mouse button around the area of Button 1, as shown in FIG. 19. By this step, the portion of the image that is to represent the area of the screen which is intended to be responsive to touch by the user is easily indicated. As seen, the new graphic file menu coordinates are now indicated.

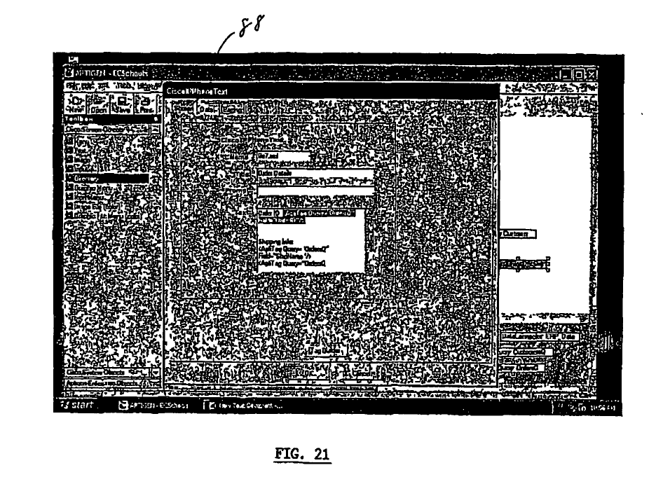

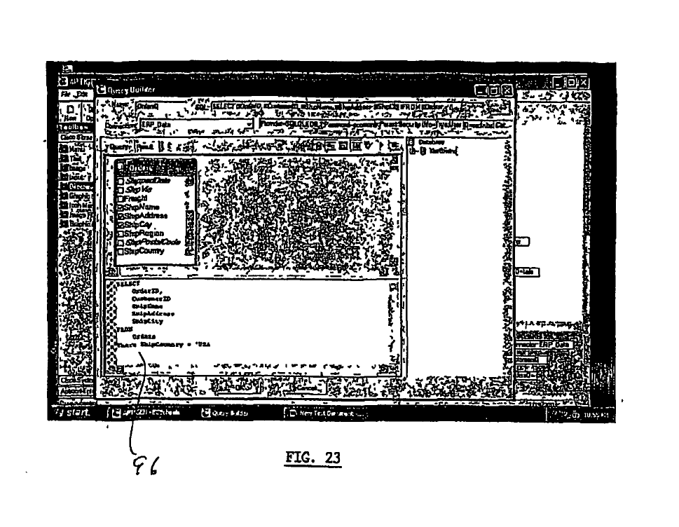

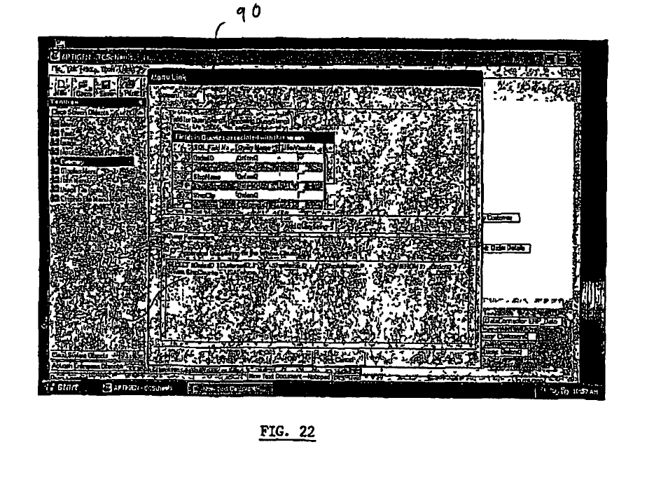

FIGS. 21, 22 and 23 show in more detail the use of tags for dynamic content. FIG. 21 shows a properties screen of a Text icon, similar to that shown in FIG. 6, except that different information is filled into the boxes or fields of the screen, and one of the tags is highlighted. It can also be seen more clearly that the screen has three tabs at the top, and that the Screen tab 88 is selected. FIG. 22 shows the properties screen of a Menu link. As indicated above, the properties of a menu link are adjusted by selecting the chosen menu link for adjustment, such as by double clicking on it. It will be seen that, of the three tabs at the top, the Data tab 90 is selected. Selecting the Data tab 90 enables the user to select which fields to include in a query. It can be seen that a check box 92 is checked, and that the check box is labeled “Appended QueryString for the Where Clause.” This “Where Clause” reference is a reference to a portion of the query in the area 94 below, where part of the query reads “Where ShipCountry=‘USA’.” The value for this Where clause is supplied from the Query Builder screen shown in FIG. 23, where the “Where ShipCountry=‘USA’” is again seen in lower area 96. By these features, data that is changing rapidly and dynamically can still be handled, queried and displayed by the system of the present invention.

Given the foregoing description, various advantages of the present invention will now be appreciated. Thus, the invention provides an application designer with the ability to construct IP telephony applications that are easy to use, since no intricate knowledge of IP telephony objects is required. This is also true because standard interfaces may be used with the present invention, such as Microsoft Windows® interfaces utilizing drag-and-drop functionality, pull-down menus, pop-up property sheets, and HTML browsers or other implementations of graphical user interfaces (GUIs). One-step application publishing to the emulator may also be provided.

It will now also be understood and appreciated that a variety of sound and video applications may be provided to IP telephones and/or emulators. It will also be understood, in a broader sense, that platforms may be provided through which IP telephony applications are designed and implemented for dynamic data transfer, web services and LDAP applications, for example. By allowing the design of custom applications within an established framework, dramatic time savings and utility may be provided, as further mentioned above.

The above description is not intended to limit the scope of the following claims, the terms of which alone define the invention. For example, it should be understood that other embodiments not specifically mentioned here that accomplish the same general principles and advantages as set forth here may do so in insubstantially different ways, while still falling within the principles of the present invention. Thus, it is contemplated that future modifications in function or result exist that are not substantial changes and that all such insubstantial changes in what is claimed are intended to be covered by the claims.

We claim:

1. A method for constructing a graphical IP telephony application, the method comprising
selecting a first tool from a toolbox,
positioning the first tool on a canvas in a desired position,
selecting a second tool from the toolbox;
positioning the second tool on the canvas in relation to the first tool,
creating a hierarchical relationship between the first tool and the second tool;
publishing the first and second tool, in accord with the hierarchical relationship, as a menu on an IP phone device.

2. A method as recited in claim 1 wherein one of the tools selected is a text tool.

3. A method as recited in claim 1 wherein one of the tools selected is an image tool to position a graphical image on the canvas.

4. A method as recited as claim 3 wherein the graphical image is suitable for use to accept input via a touch screen, and further comprising the step of selecting the portion of the image that is to represent the area of the screen which is intended to be responsive to touch by the user.

5. A method as recited in claim 1 wherein one of the tools selected accesses data that is capable of changing independent of the IP telephony application.

6. A method as recited in claim 5 further comprising the use of a directory too to access user data from an LDAP application.

7. A method as recited in claim 5 wherein the IP telephony application accesses data from a relational database application.

8. A method as recited in claim 7 wherein the relational database application is an ODB compliant database application.

9. A method as recited in claim 5 wherein the IP telephony application accesses data from a web server.

10. A method as recited in claim 1 further comprising the step of deploying the IP telephony application to an application server.

11. A method as recited in claim 10 wherein the application server is used to deliver data and/or audio information and/or video information.

12. A system for constructing a graphical IP telephony application, the system comprising
a canvas,
a toolbox having tools capable of being selected and positioned on the canvas by a designer,
at least one of the tools being a menu tool, capable of having text applied to it and displaying the text so applied, and capable of having a relationship applied to it in relation to another menu tool positioned on the same canvas.

13. A system as recited in claim 12 wherein the toolbox further includes a graphical image tool, capable of being positioned on the canvas, and of having a graphical image applied to it, and of displaying that graphical image.

14. A system as recited in claim 13 wherein the graphical image is suitable for use to accept input via a touch screen, and wherein a portion of the image that is to represent the area of the touch screen which is intended to be responsive to touch by the user is selected.

15. A system as recited in claim 11 wherein the toolbox further includes a database tool, capable of accessing data that is capable of changing independent of the IP telephony application.

16. A system as recited in claim 15 wherein the IP telephony application includes a directory tool which accesses user data from an LDAP application.

17. A system as recited in claim 12 further comprising an application server to which the IP telephony application is deployed.

18. A system as recited in claim 17 wherein the application server is used to deliver data and/or audio information and/or video information.

19. A system as recited in claim further comprising at least one template or wizard for providing a relatively untrained user with guidance in the use of the system.

20. A method allowing a designer to construct an IP telephony application accessible and employable by users of IP phone devices, comprisign the steps of
providing a plurality of the IP phone devices with an associated first visual display,
providing the designer with one or more computers having at least a second visual display;
the designer constructing the IP telephony application by visually manipulating elements on a graphical user interface associated with the at least second visual display to create data in a native format used for imparting information from the IP phone devices to the users,
wherein the designer constructs the IP telephony application and the users to use and IP phone device using the IP telephony application without either the designer or the users being aware of either the native data format used by the IP phone device or programming language used to construct the IP telephony application, and
wherein the IP phone device to receive at least one of data and an audio stream and a video stream, and display the received information on an associated handset, speaker and/or visual display.
